(19) United States
(12) Patent Application Publication
(10) Pub. No.: US 2017/0052515 A1
(43) Pub. Date: Feb. 23, 2017

(54) SYSTEM FOR APPLIANCE AUTO RESTART AFTER A POWER SUPPLY LINE INTERRUPT

(71) Applicant: General Electric Company, Schenectady, NY (US)

(72) Inventors: Eric Xavier Meusburger, Mount Prospect, IL (US); Jennifer Nicole Lea, Louisville, KY (US)

(21) Appl. No.: 14/830,880

(22) Filed: Aug. 20, 2015

(51) Int. Cl. G05B 15/02; F27D 19/00; D06F 33/02

(52) U.S. Cl. CPC G05B 15/02; D06F 33/02; F27D 19/00

(57) ABSTRACT

A system and method for restarting an appliance after a power supply interruption. A controller regularly communicates an operating status of the appliance and a power supply to a server which can send a restart command after a power supply interruption. The restart command is only communicated if the interrupt time was less than a time predetermined to be safe for restarting the appliance. Upon receiving the restart command, the controller restarts the appliance according to its most recently communicated operating status.

### FIELD OF THE INVENTION

The subject matter of the present disclosure relates generally to a system for restarting an appliance after a power outage.

### BACKGROUND OF THE INVENTION

Modern appliances, such as refrigerators, ovens, dishwashers, washing machines, etc., often require electricity to operate. Certain buildings having appliances therein are connected to electrical grids that supply electricity. In general, the electrical grid can supply electricity reliably. However, electrical grid interruptions and disturbances are inevitable and can occur for a variety of reasons. For example, severe weather, extreme grid usage during peak hours, and equipment failure can negatively affect the electrical grid and cause temporary disruptions. When these interruptions and disturbances occur, the appliances lose their supply of electricity and can no longer continue normal operation.

Power supply line interruptions may range in duration from a fraction of a second to several hours or longer. These electricity interruptions can be problematic for appliance users, especially if the appliance is in the middle of an operating cycle when the outage occurs. For example, if an appliance is in the middle of an operating cycle, the loss of power may terminate the cycle. In cases where the power loss is due only to a brief disturbance on the electrical grid, it may be safe to restart the appliance where it left off in its operating cycle. Appliances typically have a backup power supply that can power the appliance during very brief power outages. For example, an internal power supply, such as a bank of capacitors, may store enough energy to power an appliance for up to 0.6 seconds in the event of a power loss. However, in some cases, it may be desirable to restart an appliance after a power loss having a duration longer than that covered by the internal power supply.

Accordingly, a method for operating an appliance, such as an oven, during a power supply line interruption is desirable. In particular, a method for restarting an appliance according to the most recent operating cycle after a power supply line interruption would be useful.

### BRIEF DESCRIPTION OF THE INVENTION

The present invention provides a system and method for restarting an appliance after a power supply interruption. In one exemplary aspect, a controller regularly communicates an operating status of the appliance and a power supply to a server which can send a restart command after a power supply interruption. The restart command is only communicated if the interrupt time was less than a time predetermined to be safe for restarting the appliance. Upon receiving the restart command, the controller restarts the appliance according to its most recently communicated operating status. By restarting an appliance in such a manner, the size of the internal power supply of an appliance may be reduced or eliminated. In addition, appliance operation and performance may be maintained even in the event of power losses lasting longer than the internal power supply can support. Additional aspects and advantages of the invention will be set forth in part in the following description, may be apparent from the description, or may be learned through practice of the invention.

In one exemplary embodiment, the present invention provides an appliance with auto restart capability. The appliance includes a controller configured to communicate an operating status of the appliance and a power supply status to a server in regular intervals and restart the appliance after a power supply line interrupt responsive to a restart command from the server. The controller is also configured to operate the appliance based at least in part on the operating status most recently communicated to the server. The restart command is only received when a power supply line interrupt time is less than a predetermined time that indicates that the power supply line interrupt occurred due to a brief power outage.

In another exemplary embodiment, the present invention provides a method of restarting an appliance after a power loss event. The method includes the steps of periodically communicating an operating status of the appliance and a power supply status prior to the power loss event for storage on a server; receiving from the server a command to restart the appliance after the power loss event; and restarting the appliance based at least in part on the operating status most recently stored on the server. The command to restart is received only if a duration of the power loss event was less than a predetermined duration.

In still another exemplary embodiment, the present invention provides a system for automatically restarting a cooking appliance after a power outage. The system includes: a remote server for storing an operating status of the cooking appliance and a power supply status for the appliance; a cabinet defining a cooking chamber, the cooking chamber configured for receipt of food items to be cooked; a heating assembly comprising a heating element disposed within the cooking chamber; and a controller. The controller is configured to receive a user input of a selected cooking cycle and operate the heating assembly to cook the food items according to the selected cooking cycle. The controller also periodically communicates an operational status of the selected cooking cycle to the remote server and restarts the heating assembly after the power outage responsive to a restart command from the remote server to complete the cooking cycle.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an oven appliance according to an exemplary embodiment of the present subject matter.

FIG. 2 provides a sectional view of the oven appliance of FIG. 1 taken along the line 2-2 of FIG. 1.

FIG. 3 is a schematic diagram of a system for restarting an appliance after a power outage according to an exemplary embodiment of the present subject matter.

FIG. 4 is a flow chart of a method for restarting an appliance after a power outage in accordance with one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

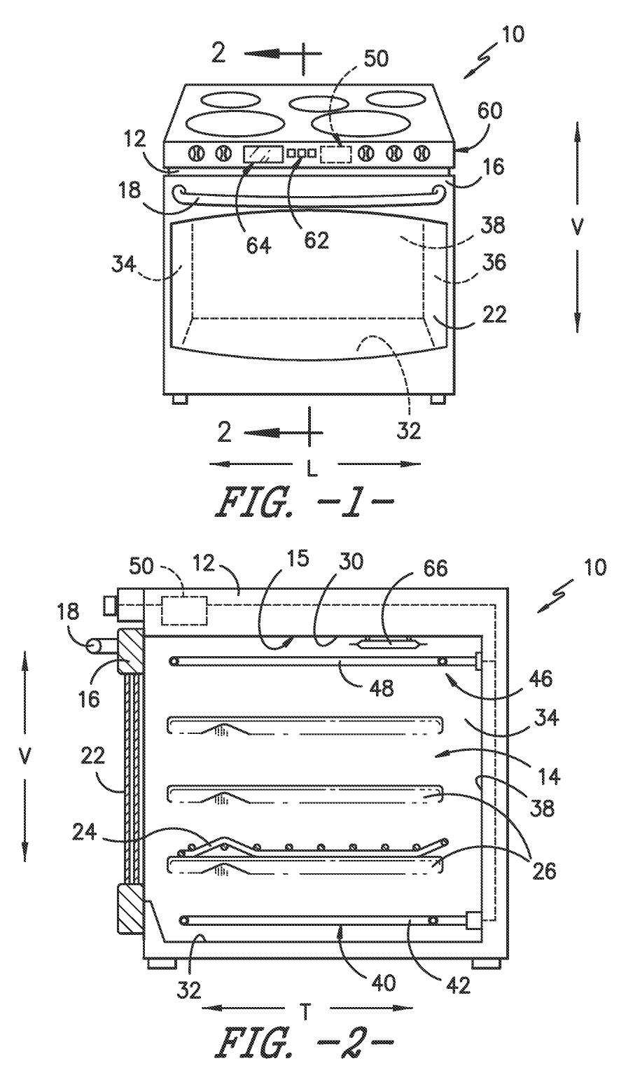

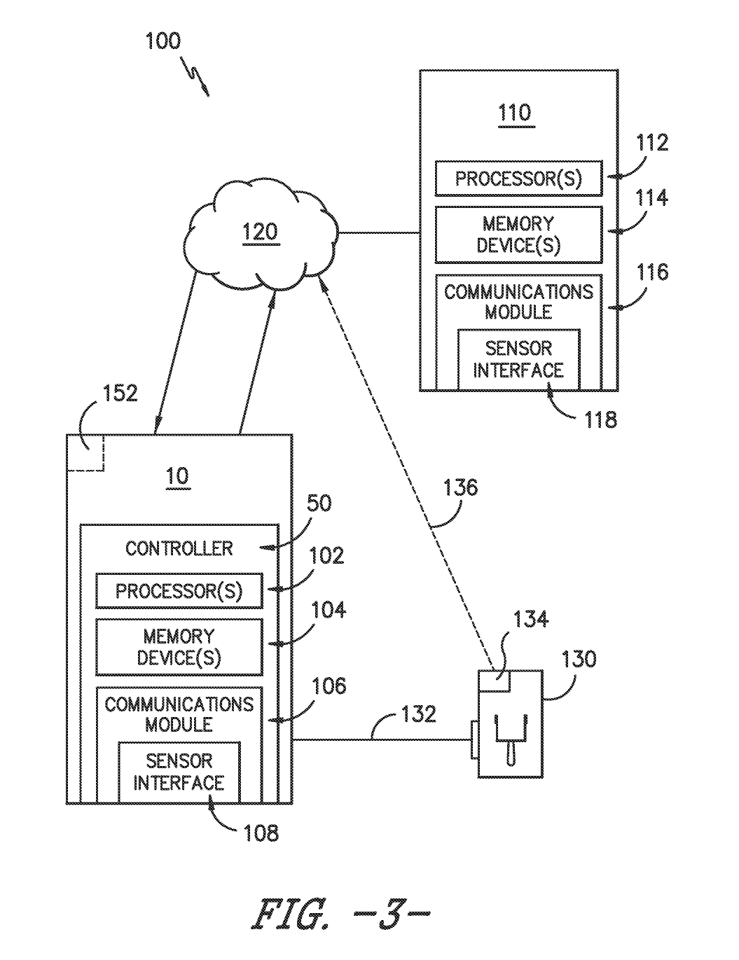

FIGS. 1 and 2 depict an exemplary oven appliance 10 that may be configured in accordance with aspects of the present disclosure. FIG. 1 provides a perspective view of oven appliance 10 according to an exemplary embodiment of the present subject matter. FIG. 2 provides a section view of oven appliance 10 taken along the 2-2 line of FIG. 1. For the particular embodiment of FIGS. 1 and 2, oven appliance 10 defines a vertical direction V, a lateral direction L and a transverse direction T. The vertical, lateral and transverse directions are mutually perpendicular and form an orthogonal direction system. As will be understood by those skilled in the art, oven appliance 10 is provided by way of example only, and the present subject matter may be used in any suitable appliance. Thus, the present subject matter may be used with other cooking appliances having different configurations, or even other types of appliances, e.g., washing machines, dishwashers, microwave ovens, etc.

Oven appliance 10 includes an insulated cabinet 12 with an interior cooking chamber 14 defined by an interior surface 15 of cabinet 12. Cooking chamber 14 is configured for the receipt of one or more food items to be cooked. Oven appliance 10 includes a door 16 rotatably mounted to cabinet 12, e.g., with a hinge (not shown). A handle 18 is mounted to door 16 and assists a user with opening and closing door 16 in order to access cooking chamber 14. For example, a user can pull on handle 18 to open or close door 16 and access cooking chamber 14.

Oven appliance 10 can includes a seal (not shown) between door 16 and cabinet 12 that assists with maintaining heat and cooking fumes within cooking chamber 14 when door 16 is closed as shown in FIG. 2. Multiple parallel glass panes 22 provide for viewing the contents of cooking chamber 14 when door 16 is closed and assist with insulating cooking chamber 14. A baking rack 24 is positioned in cooking chamber 14 for the receipt of food items or utensils containing food items. Baking rack 24 is slidably received onto embossed ribs 26 or sliding rails such that rack 24 may be conveniently moved into and out of cooking chamber 14 when door 16 is open.

As shown, various sidewalls define the cooking chamber 14. For example, cooking chamber 14 includes a top wall 30 and a bottom wall 32 which are spaced apart along the vertical direction V. Left sidewall 34 and right sidewall 36 (as defined according to the view as shown in FIG. 1) extend between the top wall 30 and bottom wall 32, and are spaced apart along the lateral direction L. A rear wall 38 may additionally extend between the top wall 30 and bottom wall 32 as well as between the left sidewall 34 and right sidewall 36, and is spaced apart from the door 16 along the transverse direction T. Cooking chamber 14 is thus defined between the top wall 30, bottom wall 32, left sidewall 34, right sidewall 36, and rear wall 38.

A lower heating assembly 40 may be included in oven appliance 10, and may include one or more heating elements 42, e.g. bake heating elements. Heating elements 42 may be disposed within the cooking chamber 14, such as adjacent bottom wall 32. In exemplary embodiments as illustrated, the lower heating elements 42 are electric heating elements, as is generally understood. Alternatively, the lower heating elements 42 may be gas burners or other suitable heating elements having other suitable heating sources. Heating elements 42 may generally be used to heat cooking chamber 14 for both cooking and cleaning of oven appliance 10.

Additionally, an upper heating assembly 46 may be included in oven appliance 10, and may include one or more upper heating elements 48, e.g. broil heating elements. Heating elements 48 may be disposed within the cooking chamber 14, such as adjacent top wall 30. In exemplary embodiments as illustrated, the upper heating elements 48 are electric heating elements, as is generally understood. Alternatively, the upper heating elements 48 may be gas burners or other suitable heating elements having other suitable heating sources. Heating elements 48 may additionally generally be used to heat cooking chamber 14 for both cooking and cleaning of oven appliance 10.

Oven appliance 10 is further equipped with a controller 50 to regulate operation of the oven appliance 10. For example, controller 50 may regulate the operation of oven appliance 10 including heating elements 42 and 48 (and heating assemblies 40, 46 generally). Controller 50 may be in communication (via for example a suitable wired or wireless connection) with the heating elements 46, 48 and other suitable components of the oven appliance 10, as discussed herein. In general, controller 50 may be operable to configure the oven appliance 10 (and various components thereof) for cooking. Such configuration may be based on a plurality of cooking factors of a selected operating cycle, as discussed herein.

By way of example, controller 50 may include one or more memory devices and one or more microprocessors, such as general or special purpose microprocessors operable to execute programming instructions or micro-control code associated with an operating cycle. The memory may represent random access memory such as DRAM, or read only memory such as ROM or FLASH. In one embodiment, the processor executes programming instructions stored in memory. The memory may be a separate component from the processor or may be included onboard within the processor.

The controller 50 may be positioned in a variety of locations throughout oven appliance 10. In the illustrated embodiment, the controller 50 may be located within a user interface panel 60 of oven appliance 10 as shown in FIGS. 1 and 2. In such an embodiment, input/output (“I/O”) signals may be routed between the control system and various operational components of oven appliance 10 along wiring harnesses that may be routed through the cabinet 12. Typically, the controller 50 is in communication with the user interface panel 60 and controls 62 through which a user may select various operational features and modes and monitor progress of the oven appliance 10. In one embodiment, the user interface 60 may represent a general purpose I/O (“GPIO”) device or functional block. In one embodiment, the user interface 60 may include input components, such as one or more of a variety of electrical, mechanical or electro-mechanical input devices including rotary dials, push buttons, and touch pads. The user interface 60 may include a display component, such as a digital or analog display device 64 designed to provide operational feedback to a user.

The user interface 60 may be in communication with controller 50 via one or more signal lines or shared communication busses. Controller 50 may also be communication with one or more sensors, e.g., a temperature sensor 66 that is used to measure temperature inside cooking chamber 14 and provide such measurements to controller 50. Temperature sensor 66 is shown (in FIG. 2) in the top and rear of cooking chamber 14. However, other locations may be used and, if desired, multiple temperature sensors may be applied as well.

It should be appreciated that the invention is not limited to any particular style, model, or configuration of oven appliance 10. The exemplary embodiment depicted in FIGS. 1 and 2 is for illustrative purposes only. For example, different locations may be provided for user interface 60, different configurations may be provided for rack 24 or ribs 26, and other differences may be applied as well. In addition, the oven appliance 10 may be a wall oven, an oven/range combo, a microwave oven, an electric oven, a gas oven, etc. Moreover, it should be appreciated that the invention is not limited to cooking appliances. Indeed, embodiments of the present invention may be practiced on dishwashers, washing machines, cooktops, or any other suitable appliance.

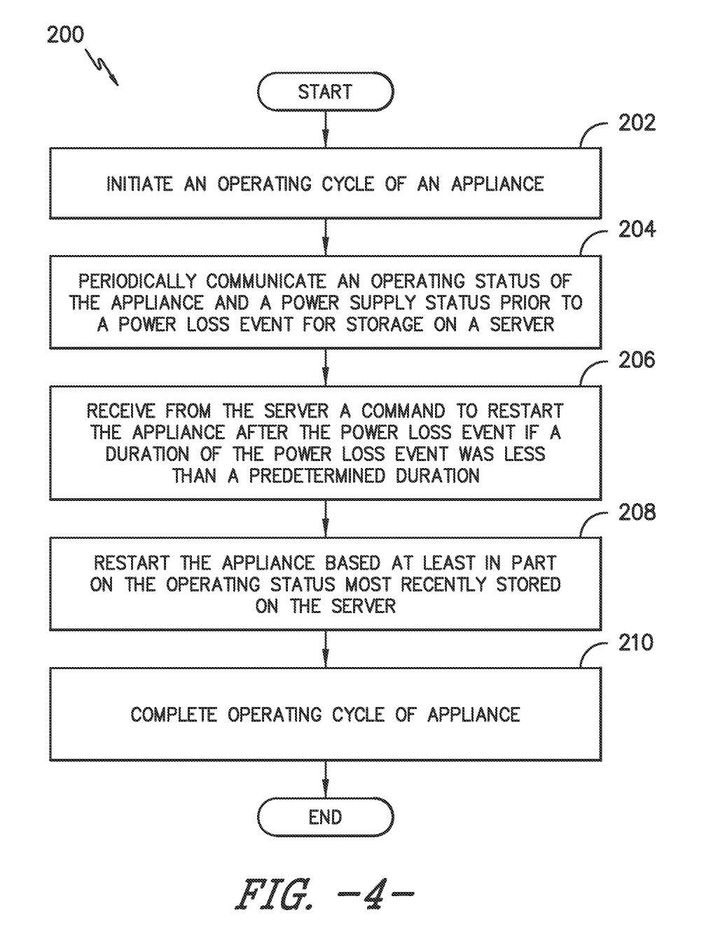

Referring now to FIG. 3, the present disclosure is further directed to a system 100 for restarting appliances after a power loss event. A system 100 may include an oven appliance 10, as discussed above. As explained above, oven appliance 10 may include controller 50. Various components of an exemplary controller 50 are illustrated in schematic fashion in FIG. 3. As shown, controller 50 may include one or more processor(s) 102 and associated memory device(s) 104 configured to perform a variety of computer-implemented functions (e.g., performing the methods, steps, and the like disclosed herein). Additionally, controller 50 may also include a communications module 106 to facilitate communications between controller 50 and various other components of the system 100, such as a remote server and a power supply, as discussed herein. For instance, the communications module 106 may serve as an interface to permit controller 50 to transmit and/or receive signals associated with operating cycles and power supply status, as discussed herein. Moreover, the communications module 106 may include an interface 108 (e.g., one or more analog-to-digital converters) to permit input signals to be converted into signals that can be understood and processed by the processor 102.

System 100 may further include a remote server 110. The remote server 110 may generally operate to store, receive and transmit signals associated with operating cycles and power supply status, and may thus be in communication with the oven appliance 10 and controller 50 thereof. For example, remote server 110 may include one or more processor(s) 112 and associated memory device(s) 114 configured to perform a variety of computer-implemented functions (e.g., performing the methods, steps, and the like disclosed herein). Additionally, the remote server 110 may also include a communications module 116 to facilitate communications between the remote server 110 and controller 50 and various other components of the system 100, such as the power supply, as discussed herein. For instance, the communications module 116 may serve as an interface to permit the remote server 110 to transmit and/or receive signals associated with operating cycles and power supply status. Moreover, the communications module 116 may include an interface 118 (e.g., one or more analog-to-digital converters) to permit input signals to be converted into signals that can be understood and processed by the processor 112.

Server 110 is remote, and thus external to the oven appliance 10, as well as other components of the system 100 such as a power supply, discussed herein. The server 110 may, for example, be in another room of a house or building in which the system 100 is utilized, or in a neighboring building, etc. Alternatively, and in exemplary embodiments, the remote server 110 is a cloud-based server 110, and is thus located at a distant location, such as in a separate state, country, etc. The remote server 110 may be in wireless communication with the oven appliance 10 (and controller 50 thereof), such as through a network 120. The network 120 may be any type of wireless communications network, such as a local area network (e.g. intranet), wide area network (e.g. Internet), or some combination thereof. The network 120 can also include a direct connection between the client devices, such as oven appliance 10, and a power supply as discussed herein, and the remote server 110. In general, communication between the remote server 110 and the client devices may be carried via a network interface using any type of wireless connection, using a variety of communication protocols (e.g. TCP/IP, HTTP, SMTP, FTP), encodings or formats (e.g. HTML, XML), and/or protection schemes (e.g. VPN, secure HTTP, SSL). Accordingly, operating cycle and status information may be transmitted from controller 50 to the remote server 110 using the network 120. Similarly, according to an example embodiment, power supply status may be transmitted from a power supply to the remote server 110 using the network, as discussed below.

Oven appliance 10 may receive power from a power supply 130. Power supply 130 may be, for example, the main circuit breaker through which electricity is routed from an electrical grid to a residential or commercial building. A power supply circuit 132 may be used to deliver the power to oven appliance 10. In the illustrated embodiment, a utility meter 134 may be in communication with remote server 110 through network 120 (as indicated by dotted line 136). In a residential setting, utility meter 134 may be, for example, a whole home meter that is in wireless communication with a home network. In an alternative embodiment, the status of the power supply 130 may be measured at any point on the power supply circuit 132, and that status may be communicated by any device capable of communicating with network 120.

Now that the details of an exemplary embodiment of the present subject matter has been described, an exemplary method 200 of restarting an appliance 150 after a power loss event will be described. According to an exemplary embodiment, the appliance 150 may be oven appliance 10. Although the discussion below refers to the exemplary method 200 of operating oven appliance 10, one skilled in the art will appreciate that the exemplary method is applicable to the operation of a variety of other appliances 150, such as dishwashers, washing machines, or microwave ovens.

At step 202, an operating cycle of the oven appliance 10 is initiated. During normal operation, oven appliance 10 periodically communicates an operating cycle status of the oven appliance 10 to a server—e.g., remote server 110—at step 204. For example, controller 50 of oven appliance 10 may initiate the communication at regular intervals with remote server 110. The frequency of communication may vary depending on the application, but the frequency of typical communications may range from several times a second to every few minutes, or at any other suitable frequency. Oven appliance 10 may be in direct communication with remote server 110 through communications modules 106 and 116. Alternatively, as discussed above, oven appliance 10 may communicate with remote server 110 by wireless communication, such as through network 120.

The remote server 110 stores the communications received from oven appliance 10. For example, the remote server 110 may store the operating status of the oven appliance 10 over a time period. According to some embodiments, the remote server 110 stores only the most recently communicated operating status. In this manner, each communication may overwrite the previously communicated operating status. According to another example embodiment, the remote server 110 maintains a history of operating status communications received from oven appliance 10. The history may go back several minutes, several days, or longer.

According to the illustrated embodiment, appliance 150 is oven appliance 10. The operating status of oven appliance 10 may include a cooking time, cooking temperature, cooking cycle information, chamber temperature, and other operating information related to the oven appliance 10. According to another example embodiment, the appliance 150 is a washing machine appliance. The operating status of the washing machine appliance may include wash time, wash cycle, water level, and other operating information related to the washing machine appliance. As explained above, these are only example embodiments, and aspects of the present invention may be applied to any other suitable appliance 150. Such applications are contemplated as within the scope of the invention.

In addition to communicating the operating status of oven appliance 10, controller 50 may communicate to the remote server 110 the power supply status prior to the power loss. According to an example embodiment, the status of power supply 130 is simply a true or false indication of whether power is being provided. However, in some embodiments, more detailed power profile information may be communicated. For example, the power supply status may include a power profile plotting the voltage, current, or total wattage provided by the power supply over time. Additional information and other configurations may be provided as well. Although example embodiments describe oven appliance 10 as initiating all communications to the remote server 110, one skilled in the art will appreciate that other sources may initiate the communications, such as, for example, remote server 110 itself.

The status of power supply 130 may be determined at the oven appliance 10, at power supply 130, or at any other suitable location in the power supply circuit 132. For example, the status of the power supply 130 may be determined at the oven appliance 10 by using controller 50 and sensor interface 108 to sense the input voltage received from the power supply circuit 132. Alternatively, the status of the power supply 130 may be measured at power supply 130, and may be communicated, for example, by utility meter 134 directly to network 120 (as indicated by dotted line 136). In this regard, the utility meter 134 may have a controller and communications module similar to the oven appliance 10. Other methods and sources for communicating the status of the power supply 130 are also possible and within the scope of the invention.

In the event of a power loss, oven appliance 10 may have an internal power supply 152 that can maintain the operation of the oven appliance 10 for a short period of time. It should be understood that as used herein, “internal” does not require that the internal power supply 152 must be located within oven appliance 10 such as within cabinet 12. Instead, “internal” is used to distinguish from the external power supply provided by e.g., the external power distribution system or power supply 130, to which oven appliance 10 is connected. As such, internal power supply 152 is preferably contained within the casing or cabinet 12 of oven appliance 10 but may be located exterior thereto as well.

Such an internal power supply 152 may be desirable, for example, because brief power shortages or supply interruptions are common for any electrical grid. For example, the internal power supply 152 may be configured to operate oven appliance 10 after a power loss event until the energy storage is depleted. In this manner, the internal power supply 152 is configured to ensure consistent operation of oven appliance 10 despite minor power supply fluctuations and disturbances.

According to an example embodiment, the internal power supply 152 may be a capacitor or a bank of capacitors capable of maintaining normal operation for up to 0.6 seconds after a power outage. If the power outage lasts longer than 0.6 seconds, operation of oven appliance 10 will stop because the energy storage of internal power supply 152 has been depleted. One skilled in the art will appreciate that other energy storage devices, for example, batteries or another suitable storage device may be used to provide temporary power in the event of an outage.

As mentioned above, oven appliance 10 will stop operating if the power loss event lasts longer than the time in which the internal power supply 152 can maintain operation. Power may be restored after this occurs, but oven appliance 10 will typically not restart absent user input. In many cases, it may be dangerous to restart oven appliance 10 after longer power loss events, for example, because the user may have left the area. However, in some cases, it is desirable to enable the oven appliance 10 to restart after a power loss event lasting long enough to deplete the internal power supply 152. Therefore, after the power loss event, the server may send the oven appliance 10 a command to restart at step 206 only if the duration of the power loss event was less than the predetermined duration, e.g., a maximum outage time. For example, to continue the example from above, it may be safe to restart operation of oven appliance 10 after a power loss lasting anywhere between 0.6 seconds and a maximum outage time, such as 3 seconds.

The maximum outage time may be preset on the controller 50 of oven appliance 10 or remote server 110. Alternatively, the maximum outage time may be set by the user. The maximum outage time can be based on a study of user tendencies or Underwriters Laboratories (UL) safety guidelines. By allowing the restart of oven appliance 10 in this manner, the internal power supply 152 may be reduced in size or eliminated completely. Although the maximum outage time is 3 seconds for the exemplary embodiment discussed above, one skilled in the art will appreciate that this time may be adjusted for the purpose of improving safety while providing an oven appliance 10 that is robust to fluctuations and brief disturbances in the power supply.

In determining whether it is safe to restart oven appliance 10, system 100 may need to account for delays in communications, such as the time it may take controller 50 to reboot after a power loss or the time it takes the controller 50 to initiate communications with the network 120 and remote server 110. For example, if oven appliance 10 fails to send a routine status update, this may indicate a power loss to oven appliance 10. However, after power is restored, controller 50 of oven appliance 10 may take a short amount of time to reboot. In addition, controller 50 may take a short amount of time to initiate communication with remote server 110 and send an updated power supply status. The remote server 110 must account for these delays in determining whether to send a restart command to oven appliance 10.

For example, if the maximum outage time is 3 seconds, the controller 50 takes 5 seconds to reboot, and network communications take 10 seconds to initialize, the remote server 110 may send a command to restart oven appliance 10 if no more than 18 seconds have passed since the power was lost—i.e., from the time the previous communication was received. If the remote server 110 receives a communication more than 18 seconds after the initial power outage, the remote server 110 will not communicate the command to restart and the oven appliance 10 will remain off.

If power has been restored and the oven appliance 10 receives the command to restart, oven appliance 10 may restart at step 208 and continue its most recent operation where it left off. For example, oven appliance 10 may be programmed to bake a turkey at 350 degrees for 4 hours. If a power outage occurs after 2 hours, but the remote server 110 determines that the power loss event was short enough that it would be safe to restart the oven appliance 10, the remote server 110 will send a command to restart. In response to that command, the oven appliance 10 would restart operation corresponding to the most recently communicated operating status to the remote server 110. In this regard, the command to restart may be accompanied with the most recent operating status. Therefore, the oven appliance 10 may restart at 350 degrees, and the timer may be set to turn off oven appliance 10 after the remaining 2 hours have lapsed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. An appliance with auto restart capability, the appliance comprising a controller configured to:
communicate an operating status of the appliance and a power supply status to a server in regular intervals;
restart the appliance after a power supply line interrupt responsive to a restart command from the server; and
operate the appliance based at least in part on the operating status most recently communicated to the server,
wherein the restart command is only received when a power supply line interrupt time is less than a predetermined time that indicates that the power supply line interrupt occurred due to a brief power outage.

2. The appliance of claim 1, wherein the appliance further comprises an internal power supply, the internal power supply configured to operate the appliance when the power supply line interrupt time is less than 0.6 seconds.

3. The appliance of claim 2, wherein the internal power supply is one or more capacitors.

4. The appliance of claim 1, wherein the power supply status is measured at a main circuit breaker.

5. The appliance of claim 1, wherein the power supply status is measured by a whole home meter.

6. The appliance of claim 1, wherein the appliance is a cooking oven and the operating status includes a cooking time or a cooking temperature.

7. The appliance of claim 1, wherein the appliance is a washing machine appliance and the operating status includes a wash time and a wash cycle.

8. A method of restarting an appliance after a power loss event, the method comprising:
periodically communicating an operating status of the appliance and a power supply status prior to the power loss event for storage on a server;
receiving from the server a command to restart the appliance after the power loss event; and
restarting the appliance based at least in part on the operating status most recently stored on the server,
wherein the command to restart is received only if a duration of the power loss event was less than a predetermined duration.

9. The method of claim 8, wherein the appliance further comprises an internal power supply, the internal power supply configured to operate the appliance when the power loss event is less than 0.6 seconds.

10. The method of claim 9, wherein the internal power supply is one or more capacitors.

11. The method of claim 8, wherein the power supply status is measured at a main circuit breaker.

12. The method of claim 8, wherein the power supply status is measured by a whole home meter.

13. The method of claim 8, wherein the appliance is a cooking oven and the operating status includes a cooking time or a cooking temperature.

14. The method of claim 8, wherein the appliance is a washing machine appliance and the operating status includes a wash time and a wash cycle.

15. A system for automatically restarting a cooking appliance after a power outage, the system comprising:
a remote server for storing an operating status of the cooking appliance and a power supply status for the appliance;
a cabinet defining a cooking chamber, the cooking chamber configured for receipt of food items to be cooked;
a heating assembly comprising a heating element disposed within the cooking chamber; and
a controller configured to:
receive a user input of a selected cooking cycle;
operate the heating assembly to cook the food items according to the selected cooking cycle;
periodically communicate an operational status of the selected cooking cycle to the remote server; and
restart the heating assembly after the power outage responsive to a restart command from the remote server to complete the cooking cycle.

16. The system of claim 15, wherein the appliance further comprises an internal power supply, the internal power supply configured to operate the appliance when the power outage time is less than 0.6 seconds.

17. The system of claim 16, wherein the internal power supply is one or more capacitors.

18. The system of claim 15, wherein the power supply status is measured at a main circuit breaker.

19. The system of claim 15, wherein the power supply status is measured by a whole home meter.

20. The system of claim 15, wherein the cooking cycle comprises a cooking temperature profile and a cooking time.
